(19) United States
(12) Patent Application Publication
(10) Pub. No.: US 2020/0320725 A1
(43) Pub. Date: Oct. 8, 2020

(54) LIGHT PROJECTION SYSTEMS

(71) Applicant: ams Sensors Singapore Pte. Ltd., Singapore (SG)

(72) Inventors: Markus Rossi, Singapore (SG); Florin Cutu, Singapore (SG)

(21) Appl. No.: 16/650,120

(22) PCT Filed: Sep. 25, 2018
(86) PCT No.: PCT/SG2018/050487

§ 371 Date: Mar. 24, 2020

Related U.S. Application Data
(60) Provisional application No. 62/563,880, filed on Sep. 27, 2017.

(51) Int. Cl. G06T 7/521; G06T 7/55; H04N 5/225; G01B 11/25

(52) U.S. Cl. CPC G06T 7/521; G01B 11/254; H04N 5/2256; G06T 7/55

(57) ABSTRACT

An optoelectronic system for collecting three-dimensional data of a scene over a minimum and maximum distance includes illumination modules, each of which is operable to generate a respective light pattern having a respective period. An imaging module is operable to collect a scene-reflected portion of each of the light patterns and is further operable to convert each collected portion into a respective signal set. Each scene-reflected portion is characterized by a respective plurality of ambiguity values and a minimum disparity value, and wherein each signal set corresponds to a respective one of the light patterns. The system includes a processor, and a non-transitory computer-readable medium comprising instructions stored thereon that, when executed by the processor, cause the processor to perform operations for determining a plurality of candidate three-dimensional data sets. Each candidate three-dimensional data set is determined from a respective one of the signal sets. The instructions also cause the processor to perform further operations for determining three-dimensional data of the scene from the plurality of candidate three-dimensional data sets.

### CROSS-REFERENCE TO RELATED APPLICATION(S)

This application claims the benefit of and priority to U.S. Provisional Patent Application No. 62/563,880, filed Sep. 27, 2017, the contents of which are incorporated herein by reference in their entirety.

### TECHNICAL FIELD

The present disclosure relates generally to light projection systems.

### BACKGROUND

Light projection systems are used in a variety of applications to cast a pattern of light upon a surface. For example, light projection systems can be used in determining the three-dimensional shape of objects. In three-dimensional shape measurement, or three-dimensional mapping, a structured light pattern, for example, can be projected onto an object or scene. In some applications, a light source projects a structured light pattern onto a scene that includes one or more objects of interest. In some structured-light assemblies, a pattern is projected onto a subject, an image of the pattern is obtained, the projected pattern is compared to the collected pattern, and differences between the two patterns are correlated with depth information. Thus, distortions in the pattern are correlated with depth. Such techniques can be useful for low-light and low-texture objects or scenes because the structured light can provide additional texture (e.g., for matching pixels in stereo images).

In some applications, projecting an irregular light pattern (i.e., a non-periodic light pattern) provides advantages. However, manufacturing an irregular array of light sources arranged to produce an irregular light pattern can be relatively costly.

### SUMMARY

As mentioned above, the ability to project an irregular (i.e., non-periodic or non-repetitive) light pattern can provide advantages for three-dimensional mapping. However, manufacturing an irregular array of light emitting devices configured to produce an irregular light pattern can be costly. The present disclosure describes techniques for obtaining three-dimensional data (e.g., disparity or distance information) by projecting regular (e.g., periodic or repetitive) light patterns onto an object or scene of interest. The techniques can be accomplished, in some cases, without using an irregular array of light emitting elements.

In one aspect, for example, the present disclosure describes an optoelectronic system for collecting three-dimensional data of a scene over a minimum and maximum distance. The system includes two or more illumination modules, wherein each illumination device is operable to generate a respective light pattern having a respective period. An imaging module is operable to collect a scene-reflected portion of each of the light patterns and is operable to convert each collected portion into a respective signal set. Each scene-reflected portion is characterized by a respective plurality of ambiguity values and a minimum disparity value, wherein each signal set corresponds to a respective one of the light patterns. A non-transitory computer-readable medium includes instructions stored thereon that, when executed by a processor, cause the processor to perform operations for determining candidate three-dimensional data sets, wherein each candidate three-dimensional data set is determined from a respective one of the signal sets, and to perform further operations for determining three-dimensional data of the scene from the plurality of candidate three-dimensional data sets.

The present disclosure also describes an optoelectronic system for collecting three-dimensional data of a scene over a minimum and maximum distance. The system includes a plurality of illumination modules, wherein each illumination device is operable to generate a respective light pattern having a respective period. An imaging module is operable to collect a scene-reflected portion of each of the light patterns and is further operable to convert each collected portion into a respective signal set. Each scene-reflected portion is characterized by a respective plurality of ambiguity values and a minimum disparity value, and wherein each signal set corresponds to a respective one of the light patterns. The system includes a processor, and a non-transitory computer-readable medium comprising instructions stored thereon that, when executed by the processor, cause the processor to perform operations for determining a plurality of candidate three-dimensional data sets. Each candidate three-dimensional data set is determined from a respective one of the signal sets. The instructions also cause the processor to perform further operations for determining three-dimensional data of the scene from the plurality of candidate three-dimensional data sets.

Some implementations include one or more of the following features. For example, the imaging module can include a plurality of pixels. In some instances, each illumination module is characterized by a baseline, and the baselines are different from one another. In some cases, each illumination module has a focusing distance, and the focusing distances are substantially equal. The imaging module can have an imaging distance, for example, that is substantially equal to any of the focusing distances.

In some implementations, the periods of the light patterns are substantially different from each other, and the minimum disparity values are substantially different from each other. Further, in some instances, each plurality of ambiguity values is characterized by a maximum value related to the minimum distance, and a minimum

In some cases, the non-transitory computer-readable medium comprises instructions stored thereon that, when executed by the processor, cause the processor to perform a further operation of deriving a collection of possible disparity values from: the period of the corresponding light pattern, the plurality of ambiguity values of the corresponding scene-reflected portion, the minimum disparity value of the corresponding scene-reflected portion, the baseline and the focusing distance of the corresponding illumination module, the imaging distance of the imaging module, and the pixel size.

In some instances, the extent of the collection of possible disparity values is proportional to the plurality of ambiguity values of the corresponding reflected portion. In some implementations, each of the illumination modules includes a respective periodic array of light emitting elements.

The disclosure also describes a host device that includes an optoelectronic system as described herein, wherein the host device is operable to use the three-dimensional data of the scene determined by the optoelectronic system for one or more functions executed by the host device.

The systems and methods described here can be used in conjunction with structured light projection systems, as well as stereoscopic light projection systems.

Other aspects, features and advantages will be readily apparent from the following detailed description, the accompanying drawings and the claims.

### BRIEF DESCRIPTION OF THE DRAWINGS

FIG. 1 is a flow chart of a method of obtaining three-dimensional data of a scene.

FIG. 2 illustrates an example of an optoelectronic system for collecting three-dimensional data of a scene.

FIG. 3 illustrates an example of a regular light pattern.

FIG. 4 illustrates various dimensions of the system of FIG. 2.

FIGS. 5A and 5B (collectively FIG. 5) illustrate an example of a process flow for obtaining three-dimensional data of a scene.

FIG. 6 illustrates another example of an optoelectronic system for collecting three-dimensional data of a scene.

### DETAILED DESCRIPTION

The present disclosure describes techniques for projecting an irregular (i.e., non-periodic or non-repetitive) light pattern that does not require an irregular array of light emitting devices. Three-dimensional data (e.g., disparity or distance information) can be obtained by projecting regular (e.g., periodic, quasi-periodic or repetitive) light patterns onto an object or scene of interest.

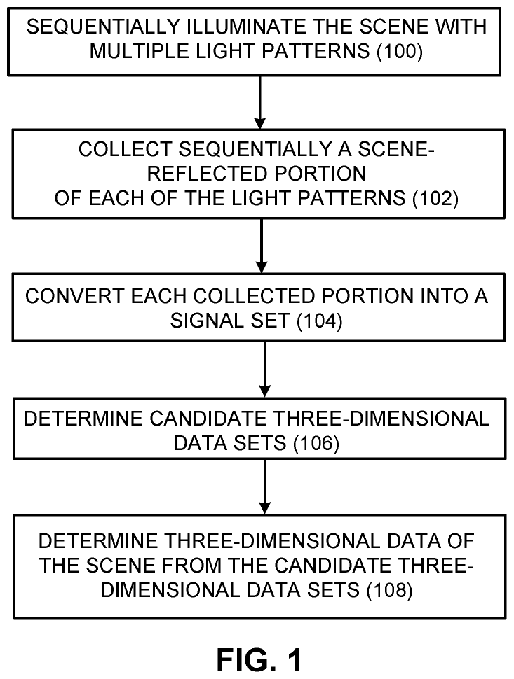

In one aspect, the disclosure describes a method for collecting, over a minimum and a maximum distance, three-dimensional data of a scene using an optoelectronic system. As indicated by FIG. 1, the method includes sequentially illuminating the scene with multiple light patterns, each of which has a respective period (100). A scene-reflected portion of each of the light patterns is collected sequentially (102), and each collected portion is converted into a signal set (104), wherein each scene-reflected portion is characterized by ambiguity values and a minimum disparity value, where each signal set corresponds to a respective one of the light patterns. The method further includes determining candidate three-dimensional data sets (106), wherein each candidate three-dimensional data set is determined from a respective one of the signal sets. The method also includes determining three-dimensional data of the scene from the candidate three-dimensional data sets (108).

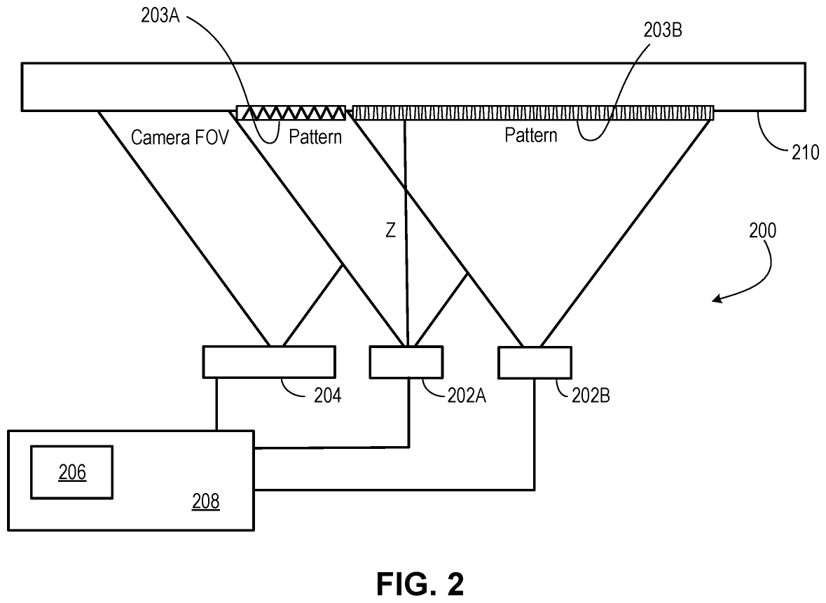

FIG. 2 illustrates an example of an optoelectronic system 200 for collecting three-dimensional data of a scene over a minimum and maximum distance and for implementing the methods described here. The system 200 includes multiple illumination modules 202A, 202B, each of which is operable to generate a respective light pattern 203A, 203B having a respective period T1, T2. The system includes an imaging module 204 operable to collect a scene-reflected portion of each of the light patterns and further operable to convert each collected portion into a signal set, wherein each scene-reflected portion is characterized by ambiguity values (i.e., a set of possible disparity vales) and a minimum disparity value, and wherein each signal set corresponds to a respective one of the light patterns. The system 200 includes a non-transitory computer-readable 206 medium (e.g., ROM other memory) comprising instructions stored thereon that, when executed by a processor 208, cause the processor to perform operations for determining candidate three-dimensional data sets, wherein each candidate three-dimensional data set is determined from a respective one of the signal sets. The processor 208 is operable to perform further operations for determining three-dimensional data of the scene from the candidate three-dimensional data sets.

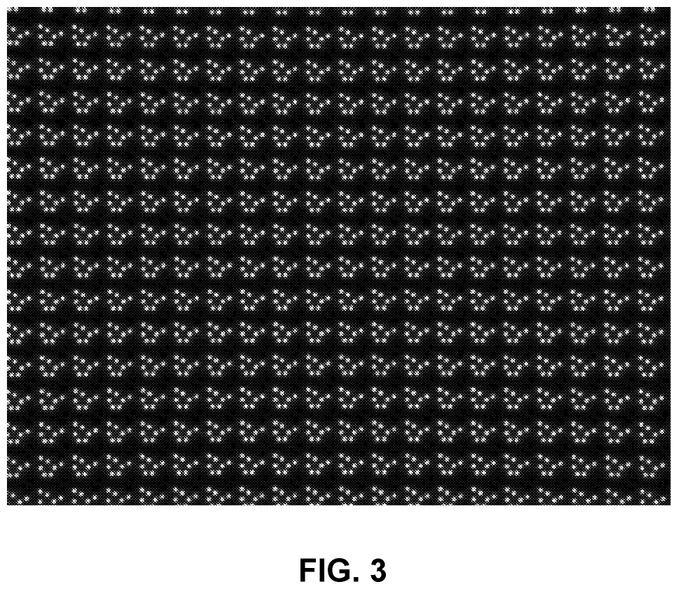

The following paragraphs describe further details according to some implementations that use two illumination modules 202A, 202B, each of which is operable to produce and project a respective light pattern 203A, 203B. The patterns 203A, 203B can be for example, regular (e.g., periodic; repetitive) or quasi-periodic. An example of such a light pattern is illustrated in FIG. 3.

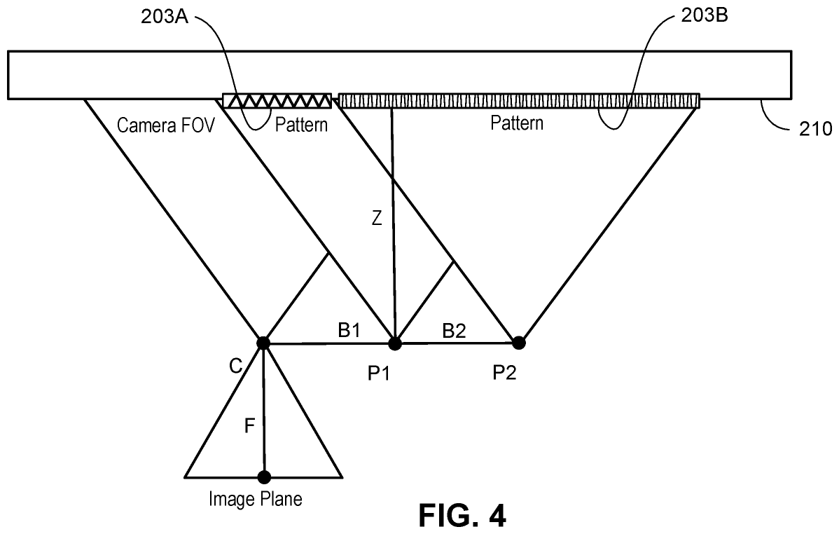

In the example of FIG. 4, it is assumed that the first illumination module 202A is operable to produce a periodic first light pattern 203A (e.g., a pattern of dots, stripes or curves) having a period T1. The baseline B1 for the first illumination module 202A is the distance from the optical center of the module 202A to the optical center C of the imaging module 204. In FIG. 4, it is further assumed that the second illumination module 202B is operable to produce a second periodic light pattern 203B (e.g., of dots, stripes or curves) having a period T2, which differs from the period T1. In some instances, the patterns 203A, 203B may be slightly tilted with respect to the epi-polar line and with respect to each other. Thus, in some cases the light patterns may be rotated relative to one another. The baseline B2 for the second illumination module 202B is the distance from the optical center of the module 202B to the optical center C of the imaging module 204. In FIG. 4, the distance from the illumination modules 202A, 202B and the imaging module 204 to a surface on which the light patterns are projected is indicated by Z. The distance value Z also may be referred to as a depth value. Further, in FIG. 4, F represents the focal length of the illumination modules 202A, 202B and the imaging module 204.

Each of the illumination modules 202A, 202B can be implemented, for example, by a respective regular (e.g., periodic) array of light emitting elements such as laser diodes or vertical cavity surface emitting lasers (VCSELs). The baselines B1, B2 for the illumination modules 202A, 202B preferably differ from one another. On the other hand, the focusing distances for the illumination modules 202A, 202B can be substantially the same. The imaging module 204 can be implemented, for example, as a CMOS or other camera that includes pixels, each of which has a particular pixel size.

In general, disparity d can be determined as follows:

d=(B*F)/Z,

where B is the baseline, F is the focal length, and Z is the distance to an object in the scene. Each light pattern 203A, 203B is used to generate a one parameter-family of solutions for depth. Thus, each light pattern 203A, 203B is used to generate a respective set of possible disparity values, which correspond to possible values of the depth or distance Z. In particular, assuming a light pattern having a period T, the disparity d can be calculated as an unknown multiple of the period T:

d=d₀+nT,

where d₀ represents the minimum possible disparity (i.e., the minimum possible shift or displacement) between a reference pattern and the input pattern. The reference pattern can be obtained, for example, during factory calibration and can be stored in memory coupled to the processor 208. In the foregoing equation, “n” is an unknown integer ≥0 and represents the ambiguity in the value of the disparity. The ambiguity results from the fact that, using a single light pattern having a period T, there are multiple possible values for the disparity (i.e., d=d₀+nT). Thus, using a single periodic light pattern results in a family or set of possible solutions for the disparity.

In operation, the illumination modules 202A, 202B sequentially illuminate a scene 210. For example, the modules 202A, 202B can project their respective light patterns onto the scene in short pulses, one after the other. In some implementations, the first module 203A briefly projects the first light pattern 203A onto the scene 210, followed by the second module briefly projecting the second light pattern 203B onto the scene. The processor 208 can be used to control the ON/OFF operation of the respective illumination modules 202A, 202B. When each respective light pattern illuminates the scene 210, a portion of the light reflected by the scene is captured by the imaging module 204, which converts the detected light into a signal set that can be provided to the processor 208. The processor 208 is operable, as explained in greater detail below, to process the signal sets generated by the imaging module 204 to determine a disparity value and, thus, a value indicative of the distance (or depth) Z to the scene 210.

In accordance with the present disclosure, the processor 208 is operable to use the signals detected by the imaging module 204—based on multiple light patterns 203A, 203B having different respective periods—to narrow down the possible values for “n” and thereby determine the correct disparity value d and the depth Z. This can be accomplished because the depth Z is assumed to be the same regardless of which illumination module 202A, 202B is being used to project the light pattern onto the scene 210. The processor 208 is operable to identify an intersection of possible disparity values based on signals detected by the imaging module 204 when the first light pattern 203A is projected onto the scene and of possible disparity values based on signals detected by the imaging module 204 when the second light pattern 203B is projected onto the scene.

Mathematically, identifying the intersection of possible disparity values is equivalent to finding possible integer values for (n₁, n₂) pairs, where

(d₀₁+n₁T₁)/B₁=(d₀₂+n₂T₂)/B₂,

and where d₀₁ and d₀₂ represent the minimum possible disparities, respectively, for the first and second light patterns 203A, 203B. All values other than n₁ and n₂ are known and can be stored, for example, in memory coupled to the processor 208.

The processor 208 also can apply another practical constraint to narrow down the possible values for (n₁, n₂) pairs. In particular, some of the possible disparity values d correspond to respective depth or distance values Z that are unrealistically small in view of the physical dimensions of the system. Thus, a minimum distance Zₘᵢₙ can be defined and stored, for example, in memory during factory calibration such that values of (n₁, n₂) pairs that correspond to distance values smaller than the minimum distance Zₘᵢₙ are ignored or discarded by the processor.

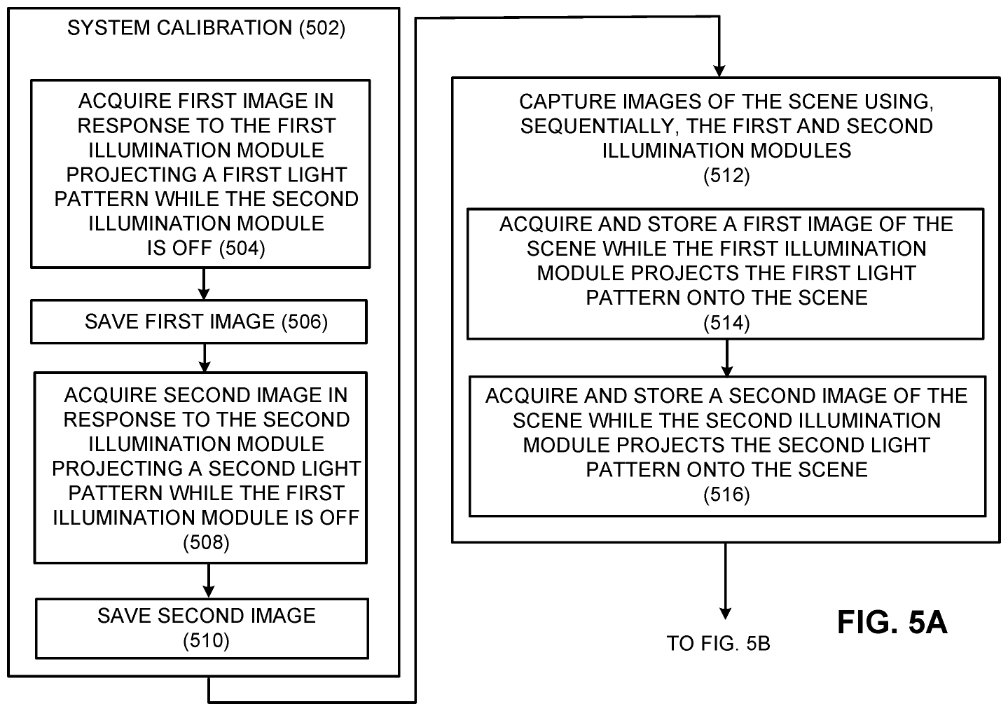

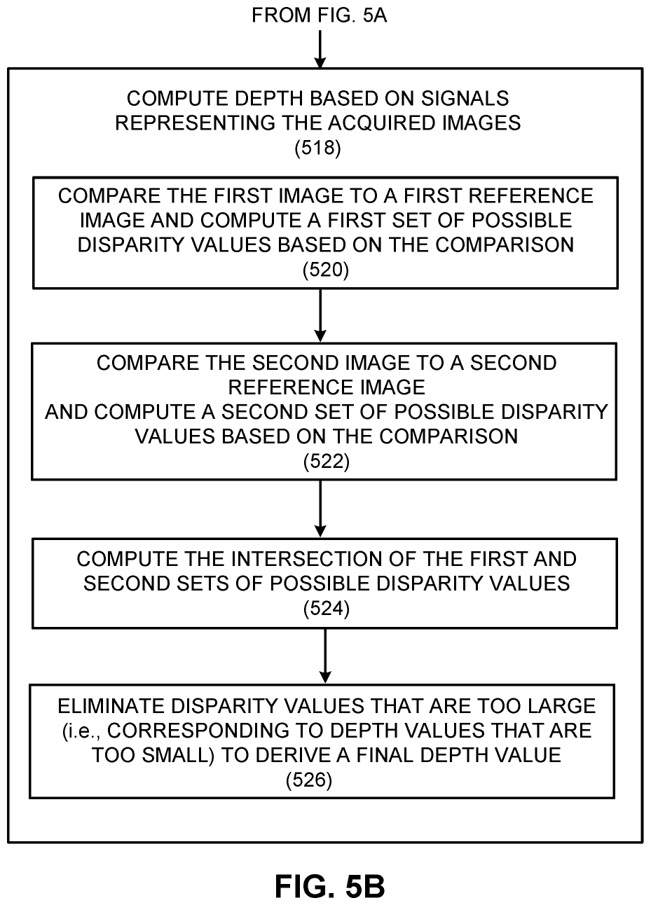

FIG. 5 illustrates a process flow in accordance with some implementations. As indicated at 502, calibration of the system can be performed, for example, during the manufacture process. Thus, the imaging module 204 can be placed at a known distance in front of a wall, with the optical axis of the imaging module set perpendicular to the wall. As part of the calibration, a first image is acquired by the imaging module 204 in response to the first illumination module 202A projecting the first light pattern 203A onto the wall while the second illumination module 202B is off (504). The first image can be saved as a first reference image in memory associated with the processor 208 (506). Further, a second image is acquired by the imaging module 204 in response to the second illumination module 202B projecting the second light pattern 203B onto the wall while the first illumination module 202A is off (508). The second image can be saved as a second reference image in memory associated with the processor 208 (510).

To measure the depth of an object in a scene, the imaging module 204 captures images of the scene using, sequentially, the first and second illumination modules 202A, 202B (512). Thus, the imaging module 204 acquires and stores a first image of the scene while the first illumination module 202A projects the first light pattern 203A onto the scene (514) and acquires and stores a second image of the scene while the second illumination module 202B projects the second light pattern 203B onto the scene (516). When the first image is acquired, the second illumination module 202B is off (i.e., the second light pattern 203B is not projected onto the scene), and when the second image is acquired, the first illumination module 202A is off (i.e., the first light pattern 203A is not projected onto the scene). Neither the object in the scene nor the imaging module should move during the interval when the two images are acquired.

Next, the processor 208 computes the depth Z based on signals representing the acquired images (518). Thus, the processor 208 compares the first image acquired to the first reference image (acquired during calibration) and computes a first set of possible disparity values based on the comparison (520). This first set of possible values corresponds to the set of values that n₁ can take. The processor 208 also compares the second image to the second reference image (acquired during calibration) and computes a second set of possible disparity values based on the comparison (522). This second set of possible values corresponds to the set of values than n₂ can take.

The processor 208 then computes the intersection of the first and second sets of possible disparity values so as to narrow down the possible disparity values that correspond to the true disparity value (524). The processor can compute the intersection, for example, by exploiting the mathematical relation between n₁ and n₂:

$${n}_{2} = a + ( b * {n}_{1} ) , \\ where$$

$$a = \frac{( {d}_{01} / {B}_{1} ) - ( {d}_{02} / {B}_{2} )}{( {T}_{2} / {B}_{2} )}$$

$$and$$

$$b = \frac{( {T}_{1} * {B}_{2} )}{( {T}_{2} * {B}_{1} )}$$

The processor 208 then eliminates disparity values that are too large (corresponding to Z values that are too small) to derive a final depth value Z (526). The processor 208 can eliminate, for example, disparity values corresponding to respective distance values Z that are unrealistically small (i.e., <Zₘᵢₙ) in view of the physical dimensions of the system. In particular, values of (n₁, n₂) pairs that correspond to distance or depth values smaller than the minimum distance Zₘᵢₙ are ignored. The (n₁, n₂) pair that corresponds to the smallest depth value equal to, or greater than, Zₘᵢₙ is assumed to be the true depth value Z. The foregoing steps can be repeated as desired so as to derive disparity (and depth) data for multiple points in the scene. The value of Zₘᵢₙ can be stored, for example, in memory associated with the processor 208 during system calibration.

The process by which the processor 208 determines the (n₁, n₂) pair that corresponds to the true disparity also can be expressed as follows. The correct value of n₁ can be found by testing possible integer values of n₁ in the range from ceil(−a/b) to (n₁)ₘₐₓ, where ceil(−a/b) is the ceiling function, which maps a/b to the smallest integer greater than or equal to a/b. The valid value for n₁ results in an integer n₂=a+b*n₁ that is in the range of 0 to (n₂)ₘₐₓ.

Although the foregoing examples are implemented using two illumination modules 202A, 202B, a greater number of illumination modules can be used in some cases. In such instances, each illumination module can project a periodic light pattern having a respective period that differs from the light pattern projected by the other illumination patterns.

As shown in FIG. 2, the system may include a single imaging module 204. In such instances, the system can be used as a structured light system in which distortions in the collected pattern(s) correlate with depth. Such techniques can be useful, for example, for low-light and low-texture objects or scenes.

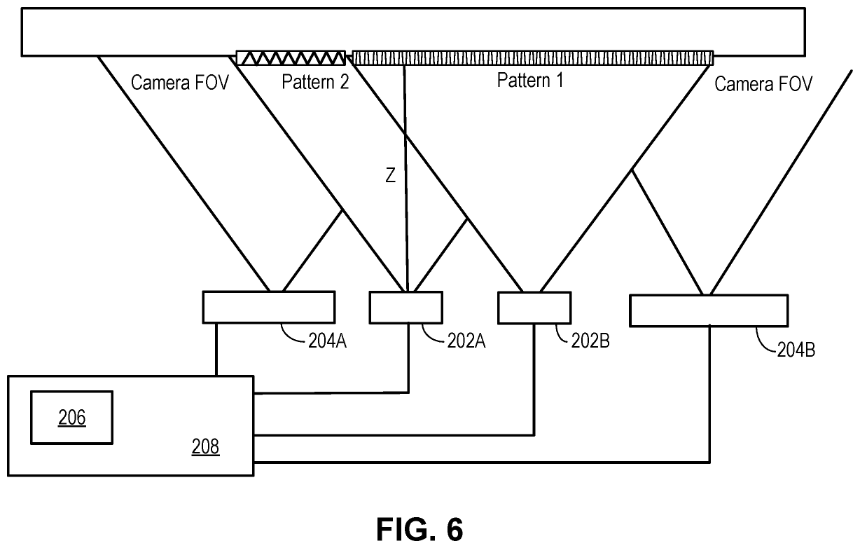

In some implementations, as shown in FIG. 6, the system 200 includes multiple imaging modules 204A, 204B, which allows stereoscopic images to be acquired and processed to produce three-dimensional depth information. In stereoscopic image capture, two (or more) imagers are spatially separated by a baseline distance. Depth information can be extracted from the measured disparity between matched pixels in each image, and the focal length of the imagers. Sometimes, an object or scene may possess either high- and low-texture or high and low-light regions, where combinations of both stereoscopic and structured-light image capture are useful for generating depth information of the entire scene.

Depending on the implementation, the illumination modules 202A, 202B may be operable to produce light patterns in the visible range, in the infra-red (IR) range and/or the ultra-violet (UV) range.

The systems and methods described above for creating and projecting light and determining disparity values can be used, for example, in association with various imaging systems, such as three-dimensional imaging and video systems. Further, light projection systems as described above, or modules incorporating such light projection systems, can be integrated into a wide range of host devices such as smartphones, laptops, wearable devices and other computing devices that may have with networking capability, as well as automobiles. The host devices may include processors and other electronic components, and other supplemental modules configured to collect data, such as cameras, time-of-flight imagers. Other supplemental modules may be included such as ambient lighting, display screens, automotive headlamps, and the like. The host devices may further include non-volatile memory where instructions for operating the optoelectronic modules, and in some instances the supplemental modules, are stored.

Modules incorporating light projection system as described above can, in some instances, obtain more accurate data than other techniques. Thus, functions performed by the host device based on signals generated by the light projection system can be performed more accurately, thereby conferring substantial advantages to the smartphone or other host device.

Various aspects of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. The computer readable medium can be a non-transitory machine-readable storage device, a machine-readable storage substrate, a memory device, a composition of matter effecting a machine-readable propagated signal, or a combination of one or more of them. The terms “data processing apparatus” and “computer” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile computing device such as a smartphone, a tablet, a personal data assistant (PDA), a notebook computer or other device with networking capability. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation also can be implemented in multiple embodiments separately or in any suitable sub-combination.

A number of embodiments have been described. Nevertheless, various modifications may be made without departing from the spirit and scope of the invention. Accordingly, other implementations are within the scope of the claims.

1. A method for collecting, over a minimum and a maximum distance, three-dimensional data of a scene using an optoelectronic system, the method comprising:
sequentially illuminating the scene with a plurality of light patterns, wherein each light pattern has a respective period;
sequentially collecting a scene-reflected portion of each of the light patterns and converting each collected portion into a respective signal set, wherein each scene-reflected portion is characterized by a respective plurality of ambiguity values and a minimum disparity value, and each signal set corresponds to a respective one of the light patterns;
determining a plurality of candidate three-dimensional data sets, wherein each candidate three-dimensional data set within the plurality is determined from a respective one of the signal sets; and
determining three-dimensional data of the scene from the plurality of candidate three-dimensional data sets.

2. The method of claim 1, wherein sequentially illuminating the scene with a plurality of light patterns includes generating each light pattern from a respective illumination module, and sequentially collecting the scene-reflected portion of each of the light patterns includes collecting the scene-reflected portions with an imaging module wherein the imaging module has a plurality of pixels.

3. The method of claim 2, wherein the illumination modules have different respective baselines, and the illumination modules have substantially equal focusing distances and the imaging module has an imaging distance and, optionally
wherein the imaging distance is substantially equal to an individual focusing distance.

4. (canceled)

5. The method of claim 1, wherein the periods are substantially different from each other, and the minimum disparity values are different from each other.

6. The method of claim 51, wherein each plurality of ambiguity values is characterized by a maximum value related to the minimum distance, and a minimum value substantially equal to zero.

7. The method of claim 1, wherein each candidate three-dimensional data set includes a collection of possible disparity values derived from:
a) the period of the corresponding light pattern,
b) the plurality of ambiguity values of the corresponding scene-reflected portion,
c) the minimum disparity value of the corresponding scene-reflected portion,
d) the baseline and the focusing distance of the corresponding illumination module,
e) the imaging distance of the imaging module, and
f) the pixel size.

8. The method of claim 7, wherein the extent of the collection of possible disparity values is proportional to the plurality of ambiguity values of the corresponding reflected portion.

9. The method of claim 7, wherein determining three-dimensional data of the scene from the plurality of candidate three-dimensional data sets includes determining a plurality of optoelectronic system constants.

10. The method of claim 9, wherein determining three-dimensional data of the scene from the plurality of candidate three-dimensional data sets includes using at least a portion of the optoelectronic system constants to select one ambiguity value from the plurality of ambiguity values for each corresponding light pattern.

11. The method of claim 10, further including using a ceiling function to select one ambiguity value from the plurality of ambiguity values for at least one corresponding light pattern, and, optionally,
including selecting one disparity value for each corresponding light pattern from the corresponding collection of possible disparity values using the selected one ambiguity value corresponding to the same light pattern, and the minimum disparity value corresponding to the same light pattern.

12. (canceled)

13. An optoelectronic system for collecting three-dimensional data of a scene over a minimum and maximum distance, the system comprising:
a plurality of illumination modules, wherein each illumination device is operable to generate a respective light pattern having a respective period;
an imaging module operable to collect a scene-reflected portion of each of the light patterns and being further operable to convert each collected portion into a respective signal set, wherein each scene-reflected portion is characterized by a respective plurality of ambiguity values and a minimum disparity value, and wherein each signal set corresponds to a respective one of the light patterns;
a processor; and
a non-transitory computer-readable medium comprising instructions stored thereon that, when executed by the processor, cause the processor to perform operations for determining a plurality of candidate three-dimensional data sets, wherein each candidate three-dimensional data set within the plurality is determined from a respective one of the signal sets, and to perform further operations for determining three-dimensional data of the scene from the plurality of candidate three-dimensional data sets.

14. The optoelectronic system of claim 13, wherein the imaging module includes a plurality of pixels.

15. The optoelectronic system of claim 13, wherein each illumination module is characterized by a baseline, and the baselines are different from one another.

16. The optoelectronic system of claim 13, wherein each illumination module has a focusing distance, and the focusing distances are substantially equal and/or,
wherein the imaging module has an imaging distance, and the imaging distance is substantially equal to any of the focusing distances.

17. (canceled)

18. The optoelectronic system of claim 13, wherein the periods are substantially different from each other, and the minimum disparity values are substantially different from each other.

19. The optoelectronic system of claim 13, wherein each plurality of ambiguity values is characterized by a maximum value related to the minimum distance, and a minimum value substantially equal to zero.

20. The optoelectronic system of claim 13, wherein the non-transitory computer-readable medium comprising instructions stored thereon that, when executed by the processor, cause the processor to perform a further operation of deriving a collection of possible disparity values from:
a) the period of the corresponding light pattern,
b) the plurality of ambiguity values of the corresponding scene-reflected portion,
c) the minimum disparity value of the corresponding scene-reflected portion,
d) the baseline and the focusing distance of the corresponding illumination module,
e) the imaging distance of the imaging module, and
f) the pixel size.

21. The optoelectronic system of claim 20, wherein the extent of the collection of possible disparity values is proportional to the plurality of ambiguity values of the corresponding reflected portion.

22. The optoelectronic system of claim 13, wherein each of the illumination modules comprises a respective periodic array of light emitting elements.

23. A host device comprising an optoelectronic system according to claim 13, wherein the host device is operable to use the three-dimensional data of the scene determined by the optoelectronic system for one or more functions executed by the host device.
